(19) United States
(12) Patent Application Publication
(10) Pub. No.: US 2019/0313102 A1
(43) Pub. Date: Oct. 10, 2019

(54) METHOD AND APPARATUS FOR ENCODING/DECODING IMAGE, AND RECORDING MEDIUM IN WHICH BIT STREAM IS STORED

(71) Applicant: ELECTRONICS AND TELECOMMUNICATIONS RESEARCH INSTITUTE, Daejeon (KR)

(72) Inventors: Seung Hyun CHO, Daejeon (KR); Sung Chang LIM, Daejeon (KR); Jung Won KANG, Daejeon (KR); Hyun Suk KO, Daejeon (KR); Jin Ho LEE, Daejeon (KR); Ha Hyun LEE, Seoul (KR); Dong San JUN, Daejeon (KR); Hui Yong KIM, Daejeon (KR); Jin Soo CHOI, Daejeon (KR)

(73) Assignee: ELECTRONICS AND TELECOMMUNICATIONS RESEARCH INSTITUTE, Daejeon (KR)

(21) Appl. No.: 16/461,001

(22) PCT Filed: Nov. 28, 2017
(86) PCT No.: PCT/KR2017/013670

§ 371 Date: May 15, 2019

(30) Foreign Application Priority Data
Nov. 28, 2016 (KR) 10-2016-0159506

(51) Int. Cl. H04N 19/129; H04N 19/91; H04N 19/18; H04N 19/159

(52) U.S. Cl. CPC H04N 19/129; H04N 19/159; H04N 19/18; H04N 19/91

(57) ABSTRACT

The present invention relates to a method for encoding and decoding an image. For this, a method for decoding an image may include: entropy-decoding a bitstream; determining a scanning unit and a scanning order of the transform coefficients of the current block; scanning and aligning the transform coefficients of the current block based on the determined scanning unit and scanning order; and performing inverse-transform for the aligned transform coefficients.

### TECHNICAL FIELD

The present invention relates to a method and apparatus for encoding/decoding and imaged, and a recording medium for storing a bitstream. In detail, the present invention relates to a method and apparatus for encoding/decoding an image, the method and apparatus being capable of adaptively determining a scanning method of a transform coefficient.

### BACKGROUND ART

Recently, the demand for high-resolution quality images such as high definition (HD) images or ultra high definition (UHD) images has increased in various application fields. However, higher resolution and quality image data have increased data amounts in comparison with conventional image data. Therefore, when transmitting image data by using a medium such as conventional wired or wireless broadband networks or when storing image data in a conventional storage medium, transmission cost and storage cost increase. In order to solve these problems occurring with an improvement in resolution and quality of image data, high-efficiency image encoding/decoding techniques are required.

Image compression technology includes various techniques, including: an inter-prediction technique of predicting a pixel value included in a current picture from a previous or subsequent picture of the current picture; an intra-prediction technique of predicting a pixel value included in a current picture by using pixel information in the current picture; an entropy encoding technique of assigning a short code to a value with a high appearance frequency and assigning a long code to a value with a low appearance frequency; etc. Image data can be effectively compressed by using such image compression technology, and the compressed image data is transmitted or stored.

### DISCLOSURE

### Technical Problem

Accordingly, the present invention provides a method and apparatus for decoding/encoding an image wherein image encoding/decoding efficiency can be improved by adaptively determining a scanning method of a transform coefficient.

### Technical Solution

A method for decoding an image according to the present invention may include: obtaining transform coefficients of a current block by entropy-decoding a bitstream; determining a scanning unit and a scanning order of the transform coefficients of the current block; scanning and aligning the transform coefficients of the current block based on the determined scanning unit and scanning order; and performing inverse-transform for the aligned transform coefficients.

In the method for decoding the image, the scanning unit may be determined based on a size of the current block and a preset threshold value.

In the method for decoding the image, the scanning unit is determined based on any one of a shape of the current block and an intra-prediction mode of the current block.

In the method for decoding the image, the scanning unit may be determined in any one of a coefficient group unit, an individual coefficient unit, and a combined unit.

In the method for decoding the image, the scanning order may be determined based on a size of the current block and a preset threshold value.

In the method for decoding the image, the scanning order may be determined based on any one of a shape of the current block and an intra-prediction mode of the current block.

In the method for decoding the image, when the scanning is performed in a coefficient group unit, scanning orders different from each other may be applied to scanning within a coefficient group and scanning between coefficient groups.

In the method for decoding the image, the scanning order may be determined based on at least one of a type of inverse-transform, a position of inverse-transform, and an area to which inverse-transform is applied.

In the method for decoding the image, when the inverse-transform is performed in an order of secondary inverse-transform and primary inverse-transform, scanning orders may be differently determined for an area for which the secondary inverse-transform is only performed, and an area for which both of the secondary inverse-transform and the primary inverse-transform are performed.

In the method for decoding the image, the scanning order of the area for which the secondary inverse-transform is performed may be determined based on at least one of a size of the current block and an intra-prediction mode of the current block, and the scanning order of the area for which both of the secondary and the primary inverse-transform are performed may be determined based on a shape of the current block.

Meanwhile, a method for encoding an image according to the present invention may include: obtaining transform coefficients of a current block by transforming a residue block of the current block; determining a scanning unit and a scanning order of the transform coefficients of the current block; and scanning and entropy-encoding the transform coefficients of the current block based on the determined scanning unit and scanning order.

In the method for encoding the image, the scanning unit may be determined based on a size of the current block and a preset threshold value.

In the method for encoding the image, the scanning unit may be determined based on any one of a shape of the current block and an intra-prediction mode of the current block.

In the method for encoding the image, the scanning unit may be determined in any one of a coefficient group unit, an individual coefficient unit, and a combined unit.

In the method for encoding the image, the scanning order may be determined based on a size of the current block and a preset threshold value.

In the method for encoding the image, the scanning order may be determined based on any one of a shape of the current block and an intra-prediction mode of the current block.

In the method for encoding the image, when the scanning is performed in a coefficient group unit, scanning orders different from each other may be applied to scanning within a coefficient group and scanning between coefficient groups.

In the method for encoding the image, the scanning order may be determined based on at least one a transform type, a transform position, and an area to which transform is applied.

In the method for encoding the image, when the transform is performed in an order of primary transform and secondary transform, scanning orders may be differently determined for an area for which the secondary inverse-transform is performed, and an area for which both of the secondary inverse-transform and the primary inverse-transform are performed.

In the method for encoding the image, the scanning order of the area for which the primary transform is performed may be determined based on at least one of a size of the current block and an intra-prediction mode of the current block, and the scanning order of the area for which both of the primary transform and the secondary transform are performed may be determined based on a shape of the current block.

Meanwhile, a recording medium according to the present invention may store a bitstream generated by using an encoding method, the method including: obtaining transform coefficients of a current block by transforming a residue block of the current block; determining a scanning unit and a scanning order of the transform coefficients of the current block; and scanning and entropy-encoding the transform coefficients of the current block based on the determined scanning unit and scanning order.

### Advantageous Effects

According to the present invention, there may be provided a method and apparatus for encoding/decoding an image, the method and apparatus being capable of adaptively determining a scanning method of a transform coefficient.

According to the present invention, image encoding and decoding efficiency may be improved.

According to the present invention, calculation complexity of image encoder and decoder may be reduced when image encoding and decoding.

### DESCRIPTION OF DRAWINGS

FIG. 1 is a block diagram showing a configuration according to an embodiment of an encoding apparatus to which the present invention is applied.

FIG. 2 is a block diagram showing a configuration according to an embodiment of a decoding apparatus to which the present invention is applied.

FIG. 3 is a view schematically showing an image division structure when image encoding and decoding.

FIG. 4 is a view for illustrating a transform set according to an intra-prediction mode.

FIG. 5 is a view for illustrating a transform process.

FIG. 6 is a view for illustrating scanning of a quantized transform coefficient.

FIGS. 7 to 9 are views for illustrating a scanning unit according to an embodiment of the present invention.

FIG. 10 is a view for illustrating a first combined diagonal scanning order and a second combined diagonal scanning order according to an embodiment of the present invention.

FIGS. 11 to 13 are views for illustrating scanning relationships between scanning within a coefficient group and scanning between coefficient groups when scanning in a coefficient group unit.

FIG. 14 is a view for illustrating an example of determining a scanning order based on a shape of a current block.

FIGS. 15 to 18 are views for illustrating an example of determining a scanning order based on an area for which transform is performed.

FIG. 19 is a flowchart for illustrating a method for decoding an image to an embodiment of the present invention.

FIG. 20 is a flowchart for illustrating a method for encoding an image according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, although the exemplary embodiments can be construed as including all modifications, equivalents, or substitutes in a technical concept and a technical scope of the present invention. The similar reference numerals refer to the same or similar functions in various aspects. In the drawings, the shapes and dimensions of elements may be exaggerated for clarity. In the following detailed description of the present invention, references are made to the accompanying drawings that show, by way of illustration, specific embodiments in which the invention may be practiced. These embodiments are described in sufficient detail to enable those skilled in the art to implement the present disclosure. It should be understood that various embodiments of the present disclosure, although different, are not necessarily mutually exclusive. For example, specific features, structures, and characteristics described herein, in connection with one embodiment, may be implemented within other embodiments without departing from the spirit and scope of the present disclosure. In addition, it should be understood that the location or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to what the claims claim.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present invention, and the ‘second’ component may also be similarly named the ‘first’ component. The term ‘and/or’ includes a combination of a plurality of items or any one of a plurality of terms.

It will be understood that when an element is simply referred to as being ‘connected to’ or ‘coupled to’ another element without being ‘directly connected to’ or ‘directly coupled to’ another element in the present description, it may be ‘directly connected to’ or ‘directly coupled to’ another element or be connected to or coupled to another element, having the other element intervening therebetween. In contrast, it should be understood that when an element is referred to as being “directly coupled” or “directly connected” to another element, there are no intervening elements present.

Furthermore, constitutional parts shown in the embodiments of the present invention are independently shown so as to represent characteristic functions different from each other. Thus, it does not mean that each constitutional part is constituted in a constitutional unit of separated hardware or software. In other words, each constitutional part includes each of enumerated constitutional parts for convenience. Thus, at least two constitutional parts of each constitutional part may be combined to form one constitutional part or one constitutional part may be divided into a plurality of constitutional parts to perform each function. The embodiment where each constitutional part is combined and the embodiment where one constitutional part is divided are also included in the scope of the present invention, if not departing from the essence of the present invention.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In other words, when a specific element is referred to as being “included”, elements other than the corresponding element are not excluded, but additional elements may be included in embodiments of the present invention or the scope of the present invention.

In addition, some of constituents may not be indispensable constituents performing essential functions of the present invention but be selective constituents improving only performance thereof. The present invention may be implemented by including only the indispensable constitutional parts for implementing the essence of the present invention except the constituents used in improving performance. The structure including only the indispensable constituents except the selective constituents used in improving only performance is also included in the scope of the present invention.

Hereinafter, embodiments of the present invention will be described in detail with reference to the accompanying drawings. In describing exemplary embodiments of the present invention, well-known functions or constructions will not be described in detail since they may unnecessarily obscure the understanding of the present invention. The same constituent elements in the drawings are denoted by the same reference numerals, and a repeated description of the same elements will be omitted.

In addition, hereinafter, an image may mean a picture configuring a video, or may mean the video itself. For example, “encoding or decoding or both of an image” may mean “encoding or decoding or both of a video”, and may mean “encoding or decoding or both of one image among images of a video.” Here, a picture and the image may have the same meaning.

### DESCRIPTION OF TERMS

Encoder: means an apparatus performing encoding.

Decoder: means an apparatus performing decoding

Block: is an M×N array of a sample. Herein, M and N mean positive integers, and the block may mean a sample array of a two-dimensional form. The block may refer to a unit. A current block my mean an encoding target block that becomes a target when encoding, or a decoding target block that becomes a target when decoding. In addition, the current block may be at least one of an encode block, a prediction block, a residual block, and a transform block.

Sample: is a basic unit constituting a block. It may be expressed as a value from 0 to 2Bd−1 according to a bit depth (Bd). In the present invention, the sample may be used as a meaning of a pixel.

Unit: refers to an encoding and decoding unit. When encoding and decoding an image, the unit may be a region generated by partitioning a single image. In addition, the unit may mean a subdivided unit when a single image is partitioned into subdivided units during encoding or decoding. When encoding and decoding an image, a predetermined process for each unit may be performed. A single unit may be partitioned into sub-units that have sizes smaller than the size of the unit. Depending on functions, the unit may mean a block, a macroblock, a coding tree unit, a code tree block, a coding unit, a coding block), a prediction unit, a prediction block, a residual unit), a residual block, a transform unit, a transform block, etc. In addition, in order to distinguish a unit from a block, the unit may include a luma component block, a chroma component block associated with the luma component block, and a syntax element of each color component block. The unit may have various sizes and forms, and particularly, the form of the unit may be a two-dimensional geometrical figure such as a rectangular shape, a square shape, a trapezoid shape, a triangular shape, a pentagonal shape, etc. In addition, unit information may include at least one of a unit type indicating the coding unit, the prediction unit, the transform unit, etc., and a unit size, a unit depth, a sequence of encoding and decoding of a unit, etc.

Coding Tree Unit: is configured with a single coding tree block of a luma component Y, and two coding tree blocks related to chroma components Cb and Cr. In addition, it may mean that including the blocks and a syntax element of each block. Each coding tree unit may be partitioned by using at least one of a quad-tree partitioning method and a binary-tree partitioning method to configure a lower unit such as coding unit, prediction unit, transform unit, etc. It may be used as a term for designating a pixel block that becomes a process unit when encoding/decoding an image as an input image.

Coding Tree Block: may be used as a term for designating any one of a Y coding tree block, Cb coding tree block, and Cr coding tree block.

Neighbor Block: means a block adjacent to a current block. The block adjacent to the current block may mean a block that comes into contact with a boundary of the current block, or a block positioned within a predetermined distance from the current block. The neighbor block may mean a block adjacent to a vertex of the current block. Herein, the block adjacent to the vertex of the current block may mean a block vertically adjacent to a neighbor block that is horizontally adjacent to the current block, or a block horizontally adjacent to a neighbor block that is vertically adjacent to the current block.

Reconstructed Neighbor block: means a neighbor block adjacent to a current block and which has been already spatially/temporally encoded or decoded. Herein, the reconstructed neighbor block may mean a reconstructed neighbor unit. A reconstructed spatial neighbor block may be a block within a current picture and which has been already reconstructed through encoding or decoding or both. A reconstructed temporal neighbor block is a block at the same position as the current block of the current picture within a reference picture, or a neighbor block thereof.

Unit Depth: means a partitioned degree of a unit. In a tree structure, a root node may be the highest node, and a leaf node may be the lowest node. In addition, when a unit is expressed as a tree structure, a level in which a unit is present may mean a unit depth.

Bitstream: means a bitstream including encoding image information.

Parameter Set: corresponds to header information among a configuration within a bitstream. At least one of a video parameter set, a sequence parameter set, a picture parameter set, and an adaptation parameter set may be included in a parameter set. In addition, a parameter set may include a slice header, and tile header information.

Parsing: may mean determination of a value of a syntax element by performing entropy decoding, or may mean the entropy decoding itself.

Symbol: may mean at least one of a syntax element, a coding parameter, and a transform coefficient value of an encoding/decoding target unit. In addition, the symbol may mean an entropy encoding target or an entropy decoding result.

Prediction Unit: means a basic unit when performing prediction such as inter-prediction, intra-prediction, inter-compensation, intra-compensation, and motion compensation. A single prediction unit may be partitioned into a plurality of partitions with a small size, or may be partitioned into a lower prediction unit.

Prediction Unit Partition: means a form obtained by partitioning a prediction unit.

Reference Picture List: means a list including one or more reference pictures used for inter-picture prediction or motion compensation. LC (List Combined), L0 (List 0), L1 (List 1), L2 (List 2), L3 (List 3) and the like are types of reference picture lists. One or more reference picture lists may be used for inter-picture prediction.

Inter-picture prediction Indicator: may mean an inter-picture prediction direction (uni-directional prediction, bi-directional prediction, and the like) of a current block. Alternatively, the inter-picture prediction indicator may mean the number of reference pictures used to generate a prediction block of a current block. Further alternatively, the inter-picture prediction indicator may mean the number of prediction blocks used to perform inter-picture prediction or motion compensation with respect to a current block.

Reference Picture Index: means an index indicating a specific reference picture in a reference picture list.

Reference Picture: may mean a picture to which a specific block refers for inter-picture prediction or motion compensation.

Motion Vector: is a two-dimensional vector used for inter-picture prediction or motion compensation and may mean an offset between a reference picture and an encoding/decoding target picture. For example, (mvX, mvY) may represent a motion vector, mvX may represent a horizontal component, and mvY may represent a vertical component.

Motion Vector Candidate: may mean a block that becomes a prediction candidate when predicting a motion vector, or a motion vector of the block. A motion vector candidate may be listed in a motion vector candidate list.

Motion Vector Candidate List: may mean a list of motion vector candidates.

Motion Vector Candidate Index: means an indicator indicating a motion vector candidate in a motion vector candidate list. It is also referred to as an index of a motion vector predictor.

Motion Information: may mean information including a motion vector, a reference picture index, an inter-picture prediction indicator, and at least any one among reference picture list information, a reference picture, a motion vector candidate, a motion vector candidate index, a merge candidate, and a merge index.

Merge Candidate List: means a list composed of merge candidates.

Merge Candidate: means a spatial merge candidate, a temporal merge candidate, a combined merge candidate, a combined bi-prediction merge candidate, a zero merge candidate, or the like. The merge candidate may have an inter-picture prediction indicator, a reference picture index for each list, and motion information such as a motion vector.

Merge Index: means information indicating a merge candidate within a merge candidate list. The merge index may indicate a block used to derive a merge candidate, among reconstructed blocks spatially and/or temporally adjacent to a current block. The merge index may indicate at least one item in the motion information possessed by a merge candidate.

Transform Unit: means a basic unit when performing encoding/decoding such as transform, inverse-transform, quantization, dequantization, transform coefficient encoding/decoding of a residual signal. A single transform unit may be partitioned into a plurality of transform units having a small size.

Scaling: means a process of multiplying a transform coefficient level by a factor. A transform coefficient may be generated by scaling a transform coefficient level. The scaling also may be referred to as dequantization.

Quantization Parameter: may mean a value used when generating a transform coefficient level of a transform coefficient during quantization. The quantization parameter also may mean a value used when generating a transform coefficient by scaling a transform coefficient level during dequantization. The quantization parameter may be a value mapped on a quantization step size.

Delta Quantization Parameter: means a difference value between a predicted quantization parameter and a quantization parameter of an encoding/decoding target unit.

Scan: means a method of sequencing coefficients within a block or a matrix. For example, changing a two-dimensional matrix of coefficients into a one-dimensional matrix may be referred to as scanning, and changing a one-dimensional matrix of coefficients into a two-dimensional matrix may be referred to as scanning or inverse scanning.

Transform Coefficient: may mean a coefficient value generated after transform is performed in an encoder. It may mean a coefficient value generated after at least one of entropy decoding and dequantization is performed in a decoder. A quantized level obtained by quantizing a transform coefficient or a residual signal, or a quantized transform coefficient level also may fall within the meaning of the transform coefficient.

Quantized Level: means a value generated by quantizing a transform coefficient or a residual signal in an encoder. Alternatively, the quantized level may mean a value that is a dequantization target to undergo dequantization in a decoder. Similarly, a quantized transform coefficient level that is a result of transform and quantization also may fall within the meaning of the quantized level.

Non-zero Transform Coefficient: means a transform coefficient having a value other than zero, or a transform coefficient level having a value other than zero.

Quantization Matrix: means a matrix used in a quantization process or a dequantization process performed to improve subjective or objective image quality. The quantization matrix also may be referred to as a scaling list.

Quantization Matrix Coefficient: means each element within a quantization matrix. The quantization matrix coefficient also may be referred to as a matrix coefficient.

Default Matrix: means a predetermined quantization matrix preliminarily defined in an encoder or a decoder.

Non-default Matrix: means a quantization matrix that is not preliminarily defined in an encoder or a decoder but is signaled by a user.

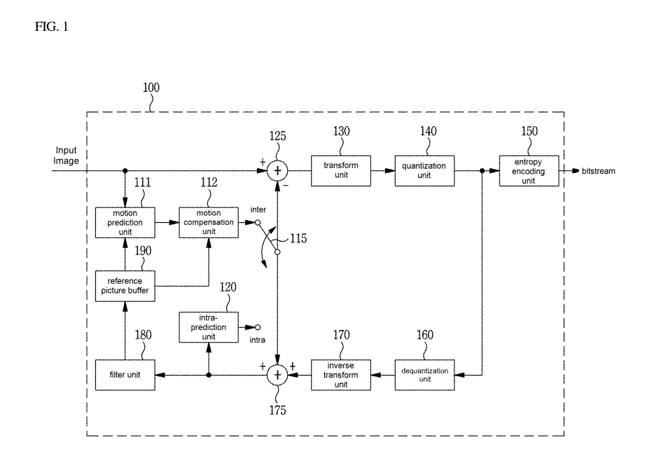

FIG. 1 is a block diagram showing a configuration of an encoding apparatus according to an embodiment to which the present invention is applied.

An encoding apparatus 100 may be an encoder, a video encoding apparatus, or an image encoding apparatus. A video may include at least one image. The encoding apparatus 100 may sequentially encode at least one image.

Referring to FIG. 1, the encoding apparatus 100 may include a motion prediction unit 111, a motion compensation unit 112, an intra-prediction unit 120, a switch 115, a subtractor 125, a transform unit 130, a quantization unit 140, an entropy encoding unit 150, a dequantization unit 160, a inverse-transform unit 170, an adder 175, a filter unit 180, and a reference picture buffer 190.

The encoding apparatus 100 may perform encoding of an input image by using an intra mode or an inter mode or both. In addition, encoding apparatus 100 may generate a bitstream through encoding the input image, and output the generated bitstream. The generated bitstream may be stored in a computer readable recording medium, or may be streamed through a wired/wireless transmission medium. When an intra mode is used as a prediction mode, the switch 115 may be switched to an intra. Alternatively, when an inter mode is used as a prediction mode, the switch 115 may be switched to an inter mode. Herein, the intra mode may mean an intra-prediction mode, and the inter mode may mean an inter-prediction mode. The encoding apparatus 100 may generate a prediction block for an input block of the input image. In addition, the encoding apparatus 100 may encode a residual of the input block and the prediction block after the prediction block being generated. The input image may be called as a current image that is a current encoding target. The input block may be called as a current block that is current encoding target, or as an encoding target block.

When a prediction mode is an intra mode, the intra-prediction unit 120 may use a pixel value of a block that has been already encoded/decoded and is adjacent to a current block as a reference pixel. The intra-prediction unit 120 may perform spatial prediction by using a reference pixel, or generate prediction samples of an input block by performing spatial prediction. Herein, the intra prediction may mean intra-prediction,

When a prediction mode is an inter mode, the motion prediction unit 111 may retrieve a region that best matches with an input block from a reference image when performing motion prediction, and deduce a motion vector by using the retrieved region. The reference image may be stored in the reference picture buffer 190.

The motion compensation unit 112 may generate a prediction block by performing motion compensation using a motion vector. Herein, inter-prediction may mean inter-prediction or motion compensation.

When the value of the motion vector is not an integer, the motion prediction unit 111 and the motion compensation unit 112 may generate the prediction block by applying an interpolation filter to a partial region of the reference picture. In order to perform inter-picture prediction or motion compensation on a coding unit, it may be determined that which mode among a skip mode, a merge mode, an advanced motion vector prediction (AMVP) mode, and a current picture referring mode is used for motion prediction and motion compensation of a prediction unit included in the corresponding coding unit. Then, inter-picture prediction or motion compensation may be differently performed depending on the determined mode.

The subtractor 125 may generate a residual block by using a residual of an input block and a prediction block. The residual block may be called as a residual signal. The residual signal may mean a difference between an original signal and a prediction signal. In addition, the residual signal may be a signal generated by transforming or quantizing, or transforming and quantizing a difference between the original signal and the prediction signal. The residual block may be a residual signal of a block unit.

The transform unit 130 may generate a transform coefficient by performing transform of a residual block, and output the generated transform coefficient. Herein, the transform coefficient may be a coefficient value generated by performing transform of the residual block. When a transform skip mode is applied, the transform unit 130 may skip transform of the residual block.

A quantized level may be generated by applying quantization to the transform coefficient or to the residual signal. Hereinafter, the quantized level may be also called as a transform coefficient in embodiments.

The quantization unit 140 may generate a quantized level by quantizing the transform coefficient or the residual signal according to a parameter, and output the generated quantized level. Herein, the quantization unit 140 may quantize the transform coefficient by using a quantization matrix.

The entropy encoding unit 150 may generate a bitstream by performing entropy encoding according to a probability distribution on values calculated by the quantization unit 140 or on coding parameter values calculated when performing encoding, and output the generated bitstream. The entropy encoding unit 150 may perform entropy encoding of pixel information of an image and information for decoding an image. For example, the information for decoding the image may include a syntax element.

When entropy encoding is applied, symbols are represented so that a smaller number of bits are assigned to a symbol having a high chance of being generated and a larger number of bits are assigned to a symbol having a low chance of being generated, and thus, the size of bit stream for symbols to be encoded may be decreased. The entropy encoding unit 150 may use an encoding method for entropy encoding such as exponential Golomb, context-adaptive variable length coding (CAVLC), context-adaptive binary arithmetic coding (CABAC), etc. For example, the entropy encoding unit 150 may perform entropy encoding by using a variable length coding/code (VLC) table. In addition, the entropy encoding unit 150 may deduce a binarization method of a target symbol and a probability model of a target symbol/bin, and perform arithmetic coding by using the deduced binarization method, and a context model.

In order to encode a transform coefficient level, the entropy encoding unit 150 may change a two-dimensional block form coefficient into a one-dimensional vector form by using a transform coefficient scanning method.

A coding parameter may include information (flag, index, etc.) such as syntax element that is encoded in an encoder and signaled to a decoder, and information derived when performing encoding or decoding. The coding parameter may mean information required when encoding or decoding an image. For example, at least one value or a combination form of a unit/block size, a unit/block depth, unit/block partition information, unit/block partition structure, whether to partition of a quad-tree form, whether to partition of a binary-tree form, a partition direction of a binary-tree form (horizontal direction or vertical direction), a partition form of a binary-tree form (symmetric partition or asymmetric partition), an intra-prediction mode/direction, a reference sample filtering method, a prediction block filtering method, a prediction block filter tap, a prediction block filter coefficient, an inter-prediction mode, motion information, a motion vector, a reference picture index, a inter-prediction angle, an inter-prediction indicator, a reference picture list, a reference picture, a motion vector predictor candidate, a motion vector candidate list, whether to use a merge mode, a merge candidate, a merge candidate list, whether to use a skip mode, an interpolation filter type, an interpolation filter tab, an interpolation filter coefficient, a motion vector size, a presentation accuracy of a motion vector, a transform type, a transform size, information of whether or not a primary (first) transform is used, information of whether or not a secondary transform is used, a primary transform index, a secondary transform index, information of whether or not a residual signal is present, a coded block pattern, a coded block flag (CBF), a quantization parameter, a quantization matrix, whether to apply an intra loop filter, an intra loop filter coefficient, an intra loop filter tab, an intra loop filter shape/form, whether to apply a deblocking filter, a deblocking filter coefficient, a deblocking filter tab, a deblocking filter strength, a deblocking filter shape/form, whether to apply an adaptive sample offset, an adaptive sample offset value, an adaptive sample offset category, an adaptive sample offset type, whether to apply an adaptive in-loop filter, an adaptive in-loop filter coefficient, an adaptive in-loop filter tab, an adaptive in-loop filter shape/form, a binarization/inverse-binarization method, a context model determining method, a context model updating method, whether to perform a regular mode, whether to perform a bypass mode, a context bin, a bypass bin, a transform coefficient, a transform coefficient level, a transform coefficient level scanning method, an image displaying/outputting sequence, slice identification information, a slice type, slice partition information, tile identification information, a tile type, tile partition information, a picture type, a bit depth, and information of a luma signal or chroma signal may be included in the coding parameter.

Herein, signaling the flag or index may mean that a corresponding flag or index is entropy encoded and included in a bitstream by an encoder, and may mean that the corresponding flag or index is entropy decoded from a bitstream by a decoder.

When the encoding apparatus 100 performs encoding through inter-prediction, an encoded current image may be used as a reference image for another image that is processed afterwards. Accordingly, the encoding apparatus 100 may reconstruct or decode the encoded current image, or store the reconstructed or decoded image as a reference image.

A quantized level may be dequantized in the dequantization unit 160, or may be inverse-transformed in the inverse-transform unit 170. A dequantized or inverse-transformed coefficient or both may be added with a prediction block by the adder 175. By adding the dequantized or inverse-transformed coefficient or both with the prediction block, a reconstructed block may be generated. Herein, the dequantized or inverse-transformed coefficient or both may mean a coefficient on which at least one of dequantization and inverse-transform is performed, and may mean a reconstructed residual block.

A reconstructed block may pass through the filter unit 180. The filter unit 180 may apply at least one of a deblocking filter, a sample adaptive offset (SAO), and an adaptive loop filter (ALF) to the reconstructed block or a reconstructed image. The filter unit 180 may be called as an in-loop filter.

The deblocking filter may remove block distortion generated in boundaries between blocks. In order to determine whether or not to apply a deblocking filter, whether or not to apply a deblocking filter to a current block may be determined based pixels included in several rows or columns which are included in the block. When a deblocking filter is applied to a block, another filter may be applied according to a required deblocking filtering strength.

In order to compensate an encoding error, a proper offset value may be added to a pixel value by using a sample adaptive offset. The sample adaptive offset may correct an offset of a deblocked image from an original image by a pixel unit. A method of partitioning pixels of an image into a predetermined number of regions, determining a region to which an offset is applied, and applying the offset to the determined region, or a method of applying an offset in consideration of edge information on each pixel may be used.

The adaptive loop filter may perform filtering based on a comparison result of the filtered reconstructed image and the original image. Pixels included in an image may be partitioned into predetermined groups, a filter to be applied to each group may be determined, and differential filtering may be performed for each group. Information of whether or not to apply the ALF may be signaled by coding units (CUs), and a form and coefficient of the ALF to be applied to each block may vary.

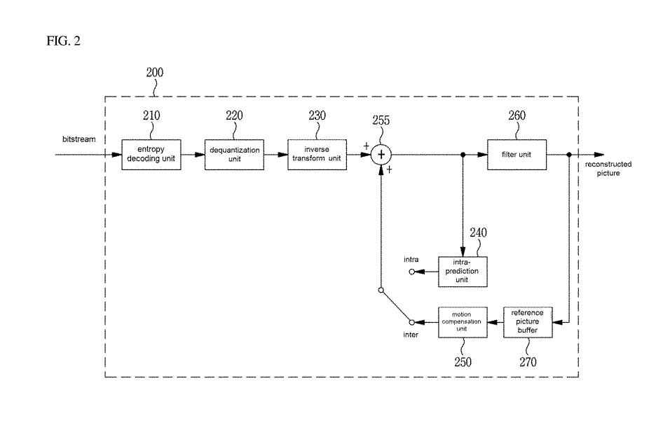

The reconstructed block or the reconstructed image having passed through the filter unit 180 may be stored in the reference picture buffer 190. FIG. 2 is a block diagram showing a configuration of a decoding apparatus according to an embodiment and to which the present invention is applied.

A decoding apparatus 200 may a decoder, a video decoding apparatus, or an image decoding apparatus.

Referring to FIG. 2, the decoding apparatus 200 may include an entropy decoding unit 210, a dequantization unit 220, a inverse-transform unit 230, an intra-prediction unit 240, a motion compensation unit 250, an adder 225, a filter unit 260, and a reference picture buffer 270.

The decoding apparatus 200 may receive a bitstream output from the encoding apparatus 100. The decoding apparatus 200 may receive a bitstream stored in a computer readable recording medium, or may receive a bitstream that is streamed through a wired/wireless transmission medium. The decoding apparatus 200 may decode the bitstream by using an intra mode or an inter mode. In addition, the decoding apparatus 200 may generate a reconstructed image generated through decoding or a decoded image, and output the reconstructed image or decoded image.

When a prediction mode used when decoding is an intra mode, a switch may be switched to an intra. Alternatively, when a prediction mode used when decoding is an inter mode, a switch may be switched to an inter mode.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block with the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be a inverse-process of the entropy encoding method described above.

In order to decode a transform coefficient level, the entropy decoding unit 210 may change a one-directional vector form coefficient into a two-dimensional block form by using a transform coefficient scanning method.

A quantized level may be dequantized in the dequantization unit 220, or inverse-transformed in the inverse-transform unit 230. The quantized level may be a result of dequantizing or inverse-transforming or both, and may be generated as a reconstructed residual block. Herein, the dequantization unit 220 may apply a quantization matrix to the quantized level.

When an intra mode is used, the intra-prediction unit 240 may generate a prediction block by performing spatial prediction that uses a pixel value of a block adjacent to a decoding target block and which has been already decoded.

When an inter mode is used, the motion compensation unit 250 may generate a prediction block by performing motion compensation that uses a motion vector and a reference image stored in the reference picture buffer 270.

The adder 225 may generate a reconstructed block by adding the reconstructed residual block with the prediction block. The filter unit 260 may apply at least one of a deblocking filter, a sample adaptive offset, and an adaptive loop filter to the reconstructed block or reconstructed image. The filter unit 260 may output the reconstructed image. The reconstructed block or reconstructed image may be stored in the reference picture buffer 270 and used when performing inter-prediction.

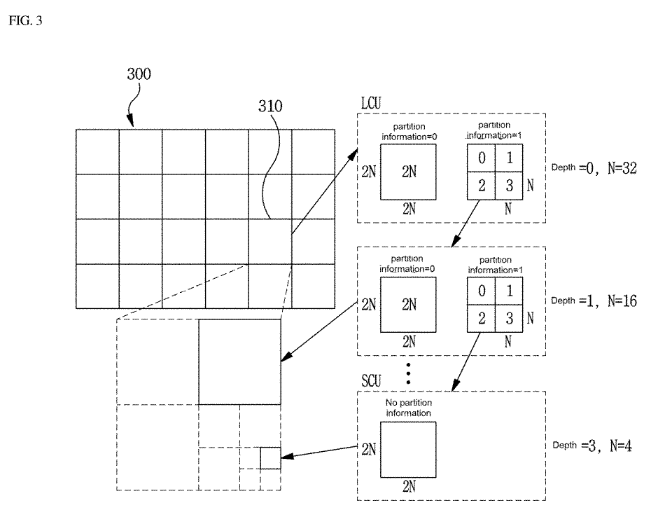

FIG. 3 is a view schematically showing a partition structure of an image when encoding and decoding the image. FIG. 3 schematically shows an example of partitioning a single unit into a plurality of lower units.

In order to efficiently partition an image, when encoding and decoding, a coding unit (CU) may be used. The coding unit may be used as a basic unit when encoding/decoding the image. In addition, the coding unit may be used as a unit for distinguishing an intra mode and an inter mode when encoding/decoding the image. The coding unit may be a basic unit used for prediction, transform, quantization, inverse-transform, dequantization, or an encoding/decoding process of a transform coefficient.

Referring to FIG. 3, an image 300 is sequentially partitioned in a largest coding unit (LCU), and a LCU unit is determined as a partition structure. Herein, the LCU may be used in the same meaning as a coding tree unit (CTU). A unit partitioning may mean partitioning a block associated with to the unit. In block partition information, information of a unit depth may be included. Depth information may represent a number of times or a degree or both in which a unit is partitioned. A single unit may be partitioned in a layer associated with depth information based on a tree structure. Each of partitioned lower unit may have depth information. Depth information may be information representing a size of a CU, and may be stored in each CU.

A partition structure may mean a distribution of a coding unit (CU) within an LCU 310. Such a distribution may be determined according to whether or not to partition a single CU into a plurality (positive integer equal to or greater than 2 including 2, 4, 8, 16, etc.) of CUs. A horizontal size and a vertical size of the CU generated by partitioning may respectively be half of a horizontal size and a vertical size of the CU before partitioning, or may respectively have sizes smaller than a horizontal size and a vertical size before partitioning according to a number of times of partitioning. The CU may be recursively partitioned into a plurality of CUs. Partitioning of the CU may be recursively performed until to a predefined depth or predefined size. For example, a depth of an LCU may be 0, and a depth of a smallest coding unit (SCU) may be a predefined maximum depth. Herein, the LCU may be a coding unit having a maximum coding unit size, and the SCU may be a coding unit having a minimum coding unit size as described above. Partitioning is started from the LCU 310, a CU depth increases by 1 as a horizontal size or a vertical size or both of the CU decreases by partitioning.

In addition, information whether or not the CU is partitioned may be represented by using partition information of the CU. The partition information may be 1-bit information. All CUs, except for a SCU, may include partition information. For example, when a value of partition information is a first value, the CU may not be partitioned, when a value of partition information is a second value, the CU may be partitioned

Referring to FIG. 3, an LCU having a depth 0 may be a 64×64 block. 0 may be a minimum depth. A SCU having a depth 3 may be an 8×8 block. 3 may be a maximum depth. A CU of a 32×32 block and a 16×16 block may be respectively represented as a depth 1 and a depth 2.

For example, when a single coding unit is partitioned into four coding units, a horizontal size and a vertical size of the four partitioned coding units may be a half size of a horizontal and vertical size of the CU before being partitioned. In one embodiment, when a coding unit having a 32×32 size is partitioned into four coding units, each of the four partitioned coding units may have a 16×16 size. When a single coding unit is partitioned into four coding units, it may be called that the coding unit may be partitioned into a quad-tree form.

For example, when a single coding unit is partitioned into two coding units, a horizontal or vertical size of the two coding units may be a half of a horizontal or vertical size of the coding unit before being partitioned. For example, when a coding unit having a 32×32 size is partitioned in a vertical direction, each of two partitioned coding units may have a size of 16×32. When a single coding unit is partitioned into two coding units, it may be called that the coding unit is partitioned in a binary-tree form. An LCU 320 of FIG. 3 is an example of an LCU to which both of partitioning of a quad-tree form and partitioning of a binary-tree form are applied.

Based on the above description, a method for encoding/decoding an image according to the present invention will be described.

In the following description, a process transform and quantization according to the present invention will be described.

A residue signal generated after intra or inter prediction may be transformed to a frequency domain by performing transform that is a part of a quantization process. Herein, as primary transform that is performed, in addition to a DCT type 2 (DCT-II), various DCT and DST kernels may be used. In such transform kernels, separable transform that respectively performs one-dimensional transform in a horizontal or vertical or both directions for a residue signal may be performed, or two-dimensional non-separable transform may be performed.

In one embodiment, as DCT and DST types used for transform, in addition to DCT-II, DCT-V, DCT-VIII, DST-I, and DST-VII may be adaptively used for one-dimensional transform as shown in the table below. For example, as shown in examples of Tables 1 and 2, a transform set may be configured to derive a DCT or DST type which is used for transform.

TABLE 1

| Transform | |
|---|---|
| Set | Transform Type |
| 0 | DST_VII, DCT-VIII |
| 1 | DST-VII, DST-I |
| 2 | DST-VII, DCT-V |

TABLE 2

| Transform | |
|---|---|
| Set | Transform Type |
| 0 | DST_VII, DCT-VIII, DST-I |
| 1 | DST-VII, DST-I, DCT-VIII |
| 2 | DST-VII, DCT-V, DST-I |

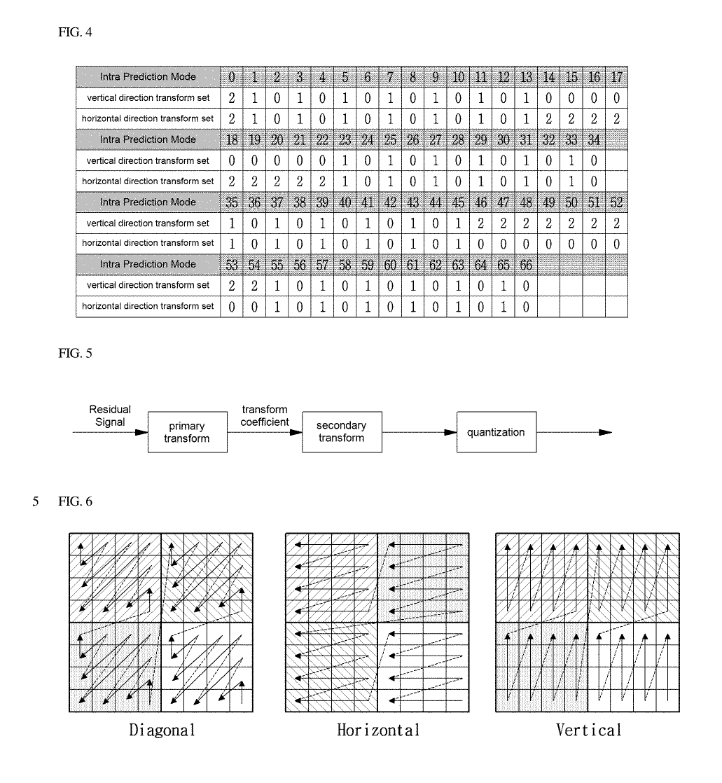

For example, as shown in FIG. 4, transform sets different from each other may be defined for a horizontal or vertical direction according to an intra-prediction mode, and an encoder/decoder may perform transform or inverse-transform or both by using an intra-prediction mode of an encoding/decoding target block, and using a transform type included in a transform set corresponding to the intra-prediction mode.

Herein, the transform set may be defined according to the same rule in the encoder/decoder rather than being entropy-encoded/decoded. Herein, information indicating which transform type is used among transform types included in a corresponding transform set may be entropy-encoded/decoded.

For example, when a block size is equal to or smaller than 64×64, three transform sets may be configured according to an intra-prediction mode as shown in an example of Table 2. Then, nine combined transform methods may be performed by using the three transform sets for horizontal directional transform and vertical directional transform, and a residue signal is encoded/decoded by using an optimized transform method, thus coding efficiency may be improved. Herein, in order to entropy-encode/decode information indicating which transform type is used among three transform types included in a single transform set, a truncated unary binarization method may be used. Herein, information indicating which transform type among transform types included in a transform set is used for at least one of vertical transform and horizontal transform may be entropy-encoded/decoded.

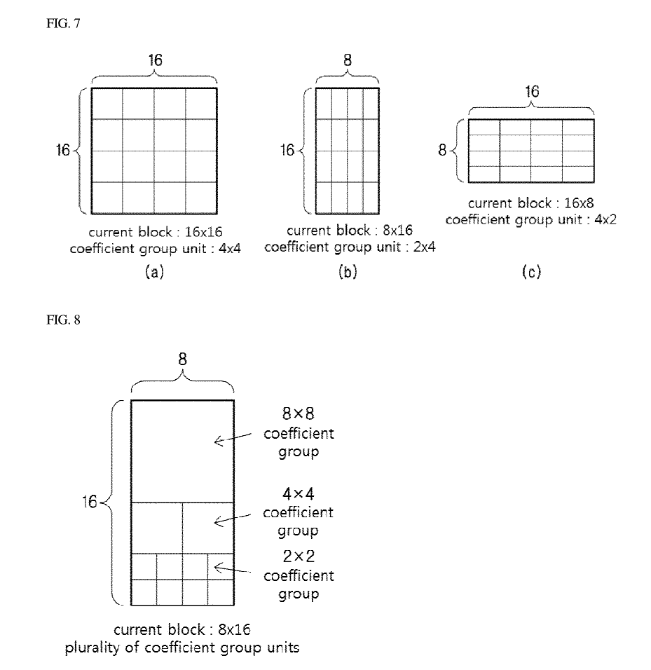

In the encoder, when primary transform described above is completed, as an example shown in FIG. 5, in order to increase energy concentration of transform coefficients, secondary transform may be performed. For secondary transform, separable transform that respectively performs one-dimensional transform in a horizontal or vertical or both directions may be performed, or two-dimensional non-separable transform may be performed. Information indicating a used transform type may be signaled or may be implicitly derived in the encoder/decoder according to current or neighbor coding information. For example, identically to primary transform, a transform set for secondary transform may be defined, and the transform set may be defined according to the same rule in the encoder/decoder rather than being entropy-encoded/decoded. Herein, information indicating which transform type is used among transform types included in a corresponding transform set may be signaled, and may be applied to at least one of residue signals by using intra or inter prediction.

At least one of a number and a type of transform candidates may vary for each transform set, and at last one of the number and the type of transform candidates may be variably determined by considering at least one of a position, a size, a division shape, a prediction mode (intra/inter mode), and an intra-prediction mode (directional/non-directional) of a block (CU, PU, TU, etc.).

In the decoder, secondary inverse-transform may be performed according whether or not to perform secondary inverse-transform. Primary inverse-transform may be performed according to whether or not to perform primary inverse-transform for the result of secondary inverse-transform.

The above described primary transform and secondary transform may be applied to at least one signal component of luma/chroma components, or may be applied according to a size/shape of an arbitrary coding block. An index indicating whether primary transform/secondary transform is used in the arbitrary coding block, and indicating used primary transform/secondary transform types may be entropy-encoded/decoded, or may be implicitly derived in the encoder/decoder according to at least one of current/neighbor coding information.

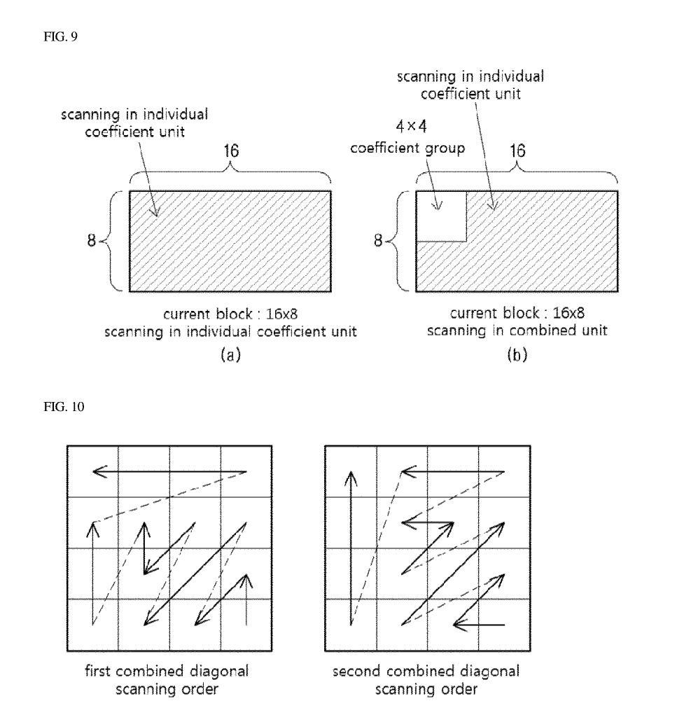

For a residue signal generated after intra or inter prediction, quantization may be performed when primary or secondary or both transform is completed, and quantized transform coefficient may be entropy-encoded. Herein, for the quantized transform coefficient, as shown in FIG. 6, scanning according to a diagonal direction, a vertical direction, and a horizontal direction may be performed based on at least one of an intra-prediction mode and a size/shape of a minimum block.

In addition, the entropy-decoded quantized transform coefficient may be aligned in a block shape by performing inverse-scanning therefor, and at least one of dequantization and inverse-transform may be performed for the corresponding block. Herein, as a method of inverse-scanning, at least one of diagonal scanning, horizontal scanning, and vertical scanning may be performed.

In one embodiment, when a size of a current coding block is 8×8, for a residue signal of the 8×8 block, primary and secondary transform, and quantization may be performed. For each of four 4×4 sub-blocks which are obtained by the above processes, entropy-encoding may be performed by scanning quantized transform coefficients thereof according to at least one of three scanning orders shown in FIG. 6. In addition, entropy-decoding may be performed by inverse-scanning the quantized transform coefficients. The inverse scanned quantized transform coefficient may become a transform coefficient after being dequantized. A reconstructed residue signal may be generated by performing at least one of secondary inverse-transform and primary inverse-transform for the transform coefficient.

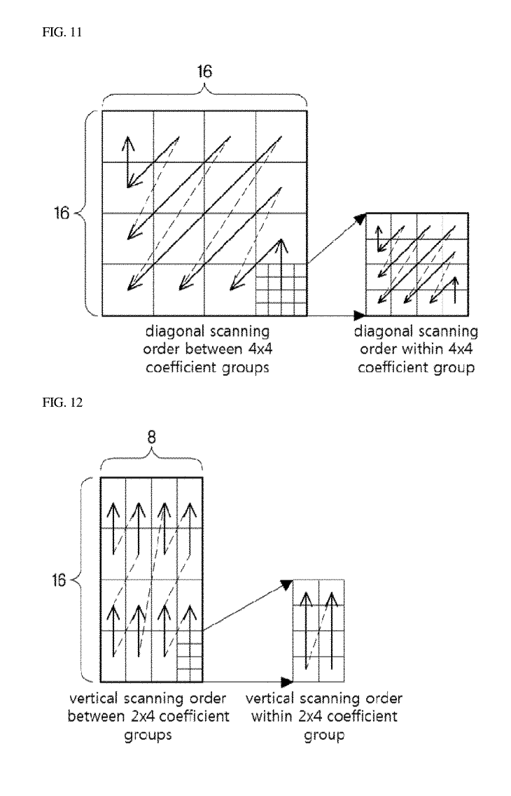

Hereinafter, with reference to FIGS. 7 to 18, a method of scanning a transform coefficient according to an embodiment of the present invention will be described in detail.

The encoder may scan transform coefficients generated by a result of primary transform performed for a residue signal of a current block, or transform coefficients generated by additionally performing secondary transform for the result of primary transform based on at least one of a scanning unit and a scanning order.

The decoder may inverse-scan entropy-decoded transform coefficients based on at least one of a scanning unit and a scanning order before performing inverse-transform. Herein, transform coefficients may be entropy-decoded coefficients or dequantized transform coefficients or both.

In the following description, a scanning unit and a scanning order of transform coefficients will be described based on the encoder. However, an inverse-scanning unit and an inverse-scanning order of transform coefficients may be described with the same method of the encoder.

The encoder may scan a transform coefficient by performing quantization therefor. Herein, the scanned transform coefficient may be entropy-encoded in the encoder.

The decoder may align a transform coefficient in a block shape by inverse-scanning entropy-decoded transform coefficient. For the transform coefficient that is aligned in a block shape, secondary inverse-transform and primary inverse-transform after the secondary inverse-transform, or the primary inverse-transform may be performed. Herein, dequantization may be performed for the transform coefficient that is aligned in a block shape, and inverse-transform (secondary inverse-transform or primary inverse-transform or both) may be performed for the dequantized transform coefficient. The inverse-transform coefficient may be a reconstructed residue signal of a current block.

In the following description, scanning may mean scanning or inverse-scanning in the encoder/decoder. In addition, a scanning order may mean a scanning method. Herein, the scanning method may indicate at least one of diagonal scanning, vertical scanning, and horizontal scanning. In addition, an individual coefficient may mean each transform coefficient.

Next, a scanning unit will be described.

Transform coefficients may be scanned in at least one scanning unit. A scanning unit of transform coefficients according to an embodiment of the present invention may be any one of a coefficient group unit, an individual coefficient unit, and a combined unit.

In one embodiment, transform coefficients within a current block may be scanned in at least one coefficient group unit of a 2N×2N, a 2N×N, a N×2N, a 3N×N, an N×3N, a 3N×2N, a 2N×3N, a 4N×N, a N×4N, a 4N×3N, and a 3N×4N (N being an integer equal to or greater than 1) size, or may be scanned in an individual coefficient unit.

A scanning unit may be determined based on a size of a current block.

In detail, the scanning unit may be determined based on a comparison of a size of a current block with a predetermined threshold value. Herein, the predetermined threshold value may mean a criterion size for determining a scanning unit, and may be represented in at least one shape of a minimum value, and a maximum value.

Meanwhile, the predetermined threshold value may be a fixed value predetermined in the encoder/decoder, or may be variable derived based on a parameter (for example, a prediction mode, an intra-prediction mode, a transform type, a scanning method, etc.) related to decoding a current block, or may be signaled through a bitstream (for example, a sequence level, a picture level, a slice level, a block level, etc.).

In one embodiment, a block in which a product of a horizontal length and a vertical length is equal to or greater than 256 may be scanned in a coefficient group unit, otherwise, other blocks may be scanned in an individual coefficient unit.

In another embodiment, a block in which a minimum length of horizontal and vertical lengths is equal to or greater than 8 may be scanned in a coefficient group unit, otherwise, other blocks may be scanned in an individual coefficient unit.

Meanwhile, a scanning unit may be determined based on a shape of a current block.

In one embodiment, when a current block has a rectangular shape, the current block may be scanned in an individual coefficient unit.

In another embodiment, when a current block has a square shape, the current block may be scanned in a coefficient group unit.

Meanwhile, a scanning unit may be determined based on an intra-prediction mode of a current block. Herein, a value of the intra-prediction mode may be considered as it is, or whether or not the intra-prediction mode is non-directional mode is may be considered, or a direction of the intra-prediction mode (for example, a vertical direction or a horizontal direction) may be considered.

In one embodiment, when an intra-prediction mode of a current block is at least one of a DC mode and a Planar mode, the current block may be scanned in a coefficient group unit.

In another embodiment, when an intra-prediction mode of a current block is a vertical mode, the current block may be scanned in an individual coefficient unit.

In addition, in another embodiment, when an intra-prediction mode of a current block is a horizontal mode, the current block may be scanned in an individual coefficient unit.

Meanwhile, information of a scanning unit may be signaled from the encoder to the decoder. Accordingly, the decoder may determine a scanning unit of a current block by using the signaled information of the scanning unit.

FIGS. 7 to 9 are views for illustrating a scanning unit according to an embodiment of the present invention.

A size of a coefficient group unit may be determined based on an aspect ratio of a current block. In addition, transform coefficients within the current block may be scanned in the same coefficient group unit. Herein, the same coefficient group unit may mean that a size of the coefficient group unit and a shape of the coefficient group unit are identical.

In one embodiment, as shown in FIG. 7(a), transform coefficients within a current block having a 16×16 size may be scanned in the same coefficient group unit.

In one embodiment, as shown in FIG. 7(b), transform coefficients within a current block having an 8×16 size may be scanned in the same coefficient group unit.

In one embodiment, as shown in FIG. 7(c), transform coefficients within a current block having a 16×8 size may be scanned in the same 4×2 coefficient group unit.

Meanwhile, transform coefficients within a current block may be scanned in different coefficient group units. Herein, the different coefficient group units may mean that at least one of a size of the coefficient group unit and a shape of the coefficient group unit is different.

In one embodiment, as shown in FIG. 8, transform coefficients within a current block having an 8×16 size may be scanned by dividing the current block into a single 8×8 coefficient group, two 4×4 coefficient groups, and eight 2×2 coefficient groups.

Meanwhile, size information of a coefficient group unit may be signaled from the encoder to the decoder. Accordingly, the decoder may determine a scanning unit of a current block by using the signaled size information of the coefficient group unit.

Meanwhile, transform coefficients within a current block may be scanned in an individual coefficient unit. Herein, scanning in the individual coefficient unit may mean scanning the entire transform coefficients of the current block rather than dividing the current block in a coefficient group.

In one embodiment, as shown in FIG. 9(a), all transform coefficients within a current block having a 16×8 size may be scanned in an individual coefficient unit.

Meanwhile, transform coefficients within a current block may be scanned in a combined unit. Herein, scanning in the combined unit may mean that coefficients belonging to a partial area among transform coefficients within a current block are scanned in a coefficient group unit, and coefficients belonging to the remaining area are scanned in an individual coefficient unit.

In one embodiment, as shown in FIG. 9(b), transform coefficients belonging to a left upper 4×4 area among transform coefficients within a current block having a 16×8 size may be scanned in a 4×4 coefficient group unit, and transform coefficients belonging to the remaining area may be scanned in an individual coefficient unit.

Next, a scanning order will be described.

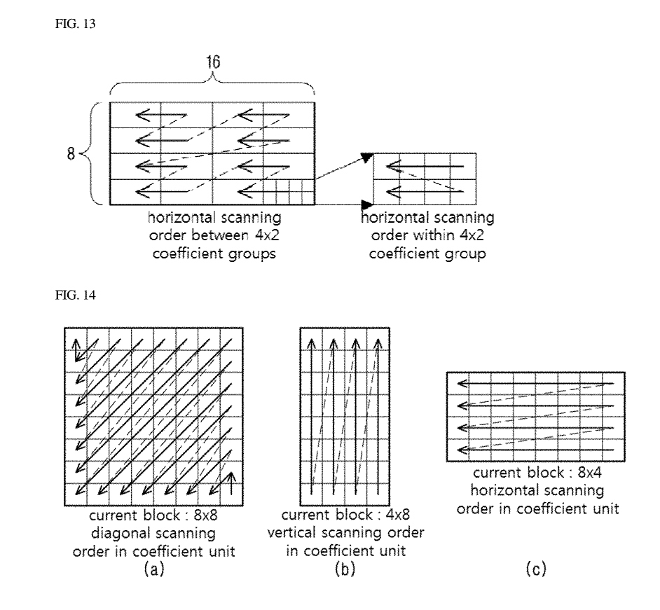

Transform coefficients may be scanned according to at least one scanning order. As a scanning order of transform coefficients according to an embodiment of the present invention, at least one of a diagonal scanning order, a horizontal scanning order, and a vertical scanning order which are shown in FIG. 6, may be used in addition to a first combined diagonal scanning order, a second combined diagonal scanning order which are shown in FIG. 10 to scan transform coefficients in an individual coefficient or transform coefficient group unit or both.

A scanning order may be determined based on a shape of a current block. Herein, the shape of the current block may be represented in an aspect ratio (horizontal length: vertical length) of the current block.

In one embodiment, when a current block has a square shape, the current block may be scanned in a diagonal scanning order. When the current block is a block having a vertical length greater than a horizontal length, the current block may be scanned in a vertical scanning order. When the current block is a block having a vertical length smaller than a horizontal length, the current block may be scanned in a horizontal scanning order.

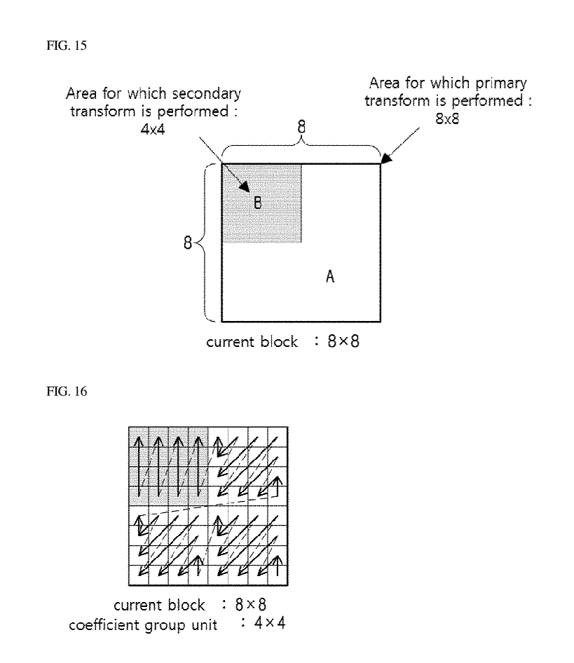

FIGS. 11 to 13 are views for illustrating scanning relationships between scanning within a coefficient group and scanning between coefficient groups when scanning in a coefficient group unit. When performing scanning in a coefficient group unit, scanning within a coefficient group, and scanning between coefficient groups may be performed by using the same scanning order.

In one embodiment, as shown in FIG. 11, when transform coefficients within a current block having a 16×16 size are scanned in a 4×4 coefficient group unit, scanning coefficients within a coefficient group and scanning coefficient group units may be performed according to a diagonal scanning order.

In another embodiment, as shown in FIG. 12, when transform coefficients within a current block having an 8×16 size is scanned in a 2×4 coefficient group unit, scanning coefficients within a coefficient group and scanning coefficient group units may be performed according to a vertical scanning order.

In addition, in another embodiment, as shown in FIG. 13, when transform coefficients within a current block having a 16×8 size are scanned in a 4×2 coefficient group unit, scanning coefficients within a coefficient group and scanning coefficient group units may be performed according to a horizontal scanning order.

Contrary to the above, when performing scanning in a coefficient group unit, scanning orders different from each other may be performed for scanning within a coefficient group and scanning between coefficient groups.

In one embodiment, when transform coefficients within a current block having a 16×16 size are scanned in a 4×4 coefficient group unit, coefficients within a coefficient group may be scanned according to a diagonal scanning order, and coefficient group units may be scanned according to a horizontal or vertical scanning order.

In another embodiment, when transform coefficients within a current block having an 8×16 size are scanned in a 2×4 coefficient group unit, coefficients within a coefficient group may be scanned according to a vertical scanning order, and coefficient group units may be scanned according to a diagonal or horizontal scanning order.

Meanwhile, when performing scanning in a coefficient group, information indicating whether or not scanning orders different from each other may be used for scanning within a coefficient group and scanning between coefficient groups may be signaled from the encoder to the decoder. In one embodiment, when performing scanning in a coefficient group, information indicating whether or not scanning orders different from each other may be used for scanning within a coefficient group and scanning between coefficient groups may be represented in a flag form.

Meanwhile, when performing scanning in an individual coefficient unit, all transform coefficients within a current block may be scanned according to a single scanning order.

When performing scanning in an individual coefficient unit, a scanning order may be determined based on a shape of a current block. Herein, the shape of the current block may be represented in an aspect ratio (horizontal length: vertical length) of the current block.

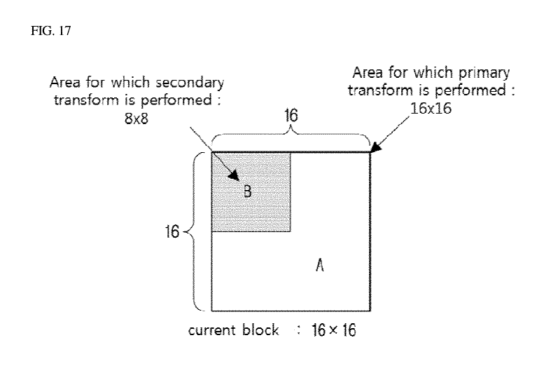

In one embodiment, as shown in FIG. 14(a), when a current block has a square shape, the current block may be scanned in a diagonal scanning order. When the current block is a block having a vertical length greater than a horizontal length as shown in FIG. 14(b), the current block may be scanned in a vertical scanning order. When the block is a block having a vertical length smaller than a horizontal length as shown in FIG. 14(c), the current block may be scanned in a horizontal scanning order.

Meanwhile, when scanning transform coefficients, a scanning order mapped according to a size or shape or both of a current block may be used. Herein, the shape may mean whether or not the current block is square, whether the current block is a non-square in a horizontal or vertical direction.

Meanwhile, a scanning order may be determined based on a size of a current block.

In detail, the scanning order may be determined based on a comparison of a size of a current block with a predetermined threshold value. Herein, the predetermined threshold value may mean a criterion size for determining the scanning unit, and may be represented in at least one of a minimum value and a maximum value.

Meanwhile, the predetermined threshold value may be a fixed value predetermined in the encoder/decoder, may be variably derived based on a parameter (for example, a prediction mode, an intra-prediction mode, a transform type, a scanning method, etc.) related to decoding a current block, or may be signaled through a bitstream (for example, a sequence level, a picture level, a slice level, a block level, etc.).

In one embodiment, for a block in which a product of a horizontal length and a vertical length is equal to or greater than 256, transform coefficient groups or individual coefficients may be scanned according to a diagonal scanning order, otherwise, transform coefficient groups or individual coefficients may be scanned in a unit of a horizontal scanning order or a vertical scanning order.

In another embodiment, for a block in which a minimum length of horizontal and vertical lengths is equal to or greater than 8, transform coefficient groups or individual coefficients may be scanned according to a diagonal scanning order, otherwise, transform coefficient groups or individual coefficients may be scanned in a unit of a horizontal scanning order or a vertical scanning order.

Meanwhile, a scanning order may be determined based on an intra-prediction mode of a current block. Herein, a value of the intra-prediction mode may be considered as it is, whether or not the intra-prediction mode is non-directional mode is may be considered, or a direction (for example, a vertical direction or a horizontal direction) of the intra-prediction mode may be considered.

In one embodiment, when an intra-prediction mode of a current block is at least one of a DC mode and a Planar mode, transform coefficient groups or individual coefficients may be scanned according to a diagonal scanning order.

In another embodiment, when an intra-prediction mode of a current block is a vertical mode, transform coefficient groups or individual coefficients may be scanned according to at least one of a vertical scanning order and a horizontal scanning order.

In addition, in another embodiment, when an intra-prediction mode of a current block is a horizontal mode, transform coefficient groups or individual coefficients may be scanned according to at least one of a vertical scanning order and a horizontal scanning order.

Meanwhile, information of a scanning order may be signaled from the encoder to the decoder. Accordingly, the decoder may determine a scanning order of a current block by using signaled information of the scanning order. In one embodiment, the information of the scanning order may be information indicating a diagonal scanning order, a vertical scanning order, a horizontal scanning order, a combined diagonal scanning order, etc.

At least one of a scanning unit and a scanning order of the above described transform coefficients may be determined based on at least one of a transform type applied to a current block, a transform position, and an area to which transform is applied. Herein, the transform position may be information indicating whether or not specific transform is used for vertical transform, or whether or not specific transform is used for horizontal transform.

When transform is performed by combining with other transform such as identity transform, according to a transform position for which identity transform is used, a scanning order may be determined. Herein, identity transform may be a matrix in which elements of the main diagonal line (diagonal line from left upper to right lower) are 1 and the remaining elements are 0 as shown in an n×n matrix In of Formula 1 below.

$${I}_{1} = [ 1 ] , \\ {I}_{2} = [ \begin{matrix}1 & 0 \\ 0 & 1\end{matrix} ] , \\ {I}_{3} = [ \begin{matrix}1 & 0 & 0 \\ 0 & 1 & 0 \\ 0 & 0 & 1\end{matrix} ] , … , \\ {I}_{n} = [ \begin{matrix}1 & 0 & … & 0 \\ 0 & 1 & … & 0 \\ ⋮ & ⋮ & ⋱ & ⋮ \\ 0 & 0 & … & 1\end{matrix} ] \qquad [ Formula 1 ]$$

In one embodiment, when transform is performed by using identity transform for horizontal transform, and using one of DCT-II, DCT-V, DCT-VIII, DST-I, DST-VI, and DST-VII for vertical transform, transform coefficient groups or individual coefficients may be scanned according to a vertical scanning order.

In another embodiment, when transform is performed by using one of DCT-II, DCT-V, DCT-VIII, DST-I, DST-VI, and DST-VII for horizontal transform, and using identity transform for vertical transform, transform coefficient groups or individual coefficients may be scanned according to a horizontal scanning order.

Meanwhile, when transform is performed by using rotational transform, a scanning order may be determined according to a rotation angle.

In one embodiment, when a rotation angle is 0 degrees, vertical scanning may be used for a coefficient group unit or an individual coefficient unit.

In one embodiment, when a rotation angle is 90 degrees, horizontal scanning may be used for a coefficient group unit or an individual coefficient unit.

In one embodiment, when a rotation angle is 180 degrees, vertical scanning may be used for a coefficient group unit or an individual coefficient unit.

In one embodiment, when a rotation angle is 270 degrees, horizontal scanning may be used for a coefficient group unit or an individual coefficient unit.

Meanwhile, when transform is performed by using Givens transform or Hyper-Givens transform, a scanning order may be determined according to a rotation angle θ. Herein, Givens transform or Hyper-Givens transform G(m, n, θ) may be defined based on a representative definition represented in Formula 2 below.

$${G}_{i , j} ( m , n ) = \{ \begin{matrix}cos θ , & i = j = m or i = j = n , \\ sin θ , & i = m , j = n , \\ - sin θ , & i = n , j = m , \\ 1 , & i = j and i \neq m and i \neq n , \\ 0 , & otherwise\end{matrix} . \qquad [ Formula 2 ]$$

In one embodiment, when a rotation angle θ is 0 degrees, vertical scanning may be used for a coefficient group unit or an individual coefficient unit.

In one embodiment, when a rotation angle θ is 90 degrees, horizontal scanning may be used for a coefficient group unit or an individual coefficient unit.

In one embodiment, when a rotation angle θ is 180 degrees, vertical scanning may be used for a coefficient group unit or an individual coefficient unit.

In one embodiment, when a rotation angle θ is 270 degrees, vertical scanning may be used for a coefficient group unit or an individual coefficient unit.

Meanwhile, when DCT or DST transform is performed for a transform block, a scanning order may be determined according to which transform of DCT transform and DST transform is used for vertical transform or horizontal transform. Herein, DCT transform may mean at least one of DCT-II, DCT-V, and DCT-VIII. In addition, DST transform may mean at least one of DST-I, DST-VI, and DST-VII.

In one embodiment, when transform is performed by using DCT transform for horizontal transform and using DST transform for vertical transform, a transform coefficient group or an individual coefficient may be scanned according to a vertical scanning order.

In one embodiment, when transform is performed by using DST transform for horizontal transform and using DCT transform for vertical transform, a transform coefficient group or an individual coefficient may be scanned according to a horizontal scanning order.

A current block may include at least one of an area in which transform is skipped, an area for which primary transform is performed, and an area for which primary transform and secondary transform are performed. Herein, the current block may be scanned according to a predetermined scanning order for each area. When secondary transform is additionally performed for a partial area of the result generated by performing primary transform for the current block, transform coefficients may be scanned by dividing by areas according to whether or not each transform is applied.

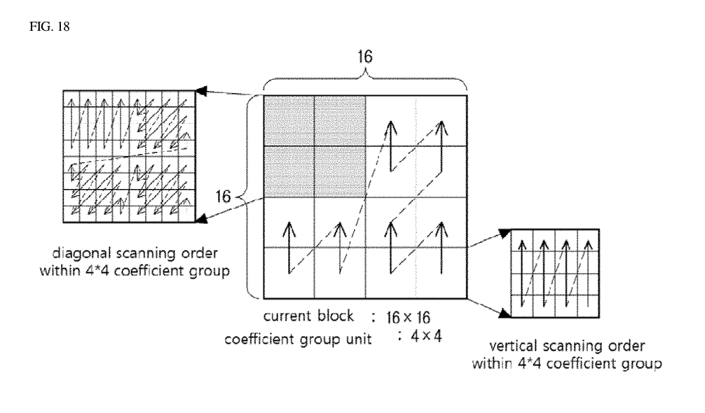

FIG. 15 shows a case in which primary transform is performed for an 8×8 current block, then secondary transform is performed for a left upper 4×4 area (gray colored area) after performing primary transform. Herein, transform coefficients may be scanned by dividing an area for which primary transform is performed, and an area for which primary transform and secondary transform are performed into an area A and an area B. An identical size or different sizes of a coefficient group unit may be used for the area A and the area B, and an identical or different scanning orders may be used between areas.

In one embodiment, scanning in a 4×4 coefficient group unit may be identically used for the area A and the area B, and a diagonal scanning order may be used for all areas.

In another embodiment, as shown in FIG. 16, a 4×4 coefficient group unit may be identically used for scanning the area A and the area B, a diagonal scanning order may be used for coefficient group units within the area A, and a vertical scanning order may be used for coefficient group units within the area B.

FIG. 17 shows a case in which primary transform is performed for a 16×16 current block, and secondary transform is performed for a left upper 8×8 area (gray colored area) after performing primary transform. Herein, transform coefficients may be scanned by dividing an area for which primary transform is performed, and an area for which primary transform and secondary transform are performed into an area A and an area B. An identical size or different sizes of a coefficient group unit may be used for the area A and the area B, and an identical or different scanning orders may be used between areas.

In one embodiment, scanning in a 4×4 coefficient group unit may be identically used for the area A and the area B, and a diagonal scanning order may be identically used for all areas.

In another embodiment, as shown in FIG. 18, scanning in a 4×4 coefficient group unit may be identically used for the area A and the area B, a vertical scanning order may be used for coefficient group units within the area A, and a diagonal scanning order may be used for coefficient group units within the area B.

In addition, in another embodiment, scanning in 4×4 and 8×8 coefficient units may be respectively used for the area A and the area B, a vertical scanning order may be used for coefficient units within the area A, and a diagonal scanning order may be used for coefficient units within the area B.

Meanwhile, a scanning order of the area for which primary transform is performed may be determined based on a size of a current block and an intra-prediction mode of the current block.

In addition, a scanning order of the area for which primary transform and secondary transform are performed may be determined based on a shape of the current block, or a pre-defined scanning order may be applied. Herein, the pre-defined scanning order may be a scanning order that is commonly set in the encoder/decoder. Meanwhile, information of the pre-defined scanning order of the area for which primary transform and secondary transform are performed may be signaled from the encoder to the decoder.

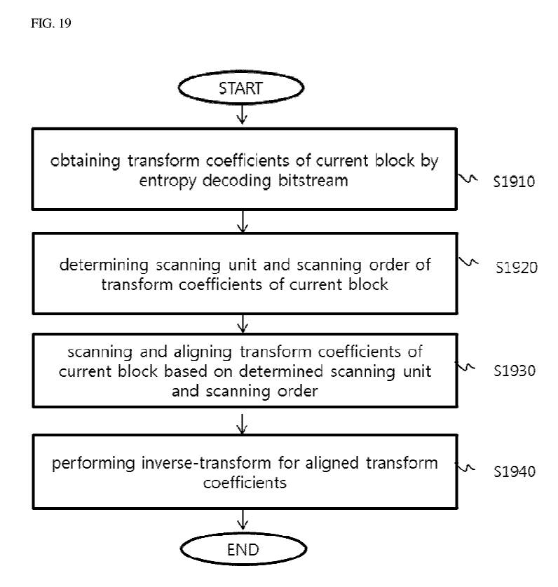

FIG. 19 is a flowchart showing a method for decoding an image according to an embodiment of the present invention.

Referring to FIG. 19, in step S1910, the decoder may obtain transform coefficients of a current block by entropy-decoding a bitstream.

In addition, in step S1920, the decoder may determine a scanning unit and a scanning order of the transform coefficients of the current block.

Herein, the scanning unit may be determined in any one of a coefficient group unit, an individual coefficient unit, and a combined unit, and the scanning order may be determined in any one of a diagonal scanning order, a vertical scanning order, a horizontal scanning order, and a combined diagonal scanning order.

Meanwhile, the scanning unit may be determined based on a size of the current block and a preset threshold value, or may be determined based on any one of a shape of the current block and an intra-prediction mode of the current block.

Meanwhile, the scanning order may be determined based on a size of the current block and a preset threshold value, or may be determined based on any one of a shape of the current block, and an intra-prediction mode of the current block.

Herein, when scanning in a coefficient group unit is performed, scanning orders different from each other may be applied to scanning within a coefficient group and scanning between coefficient groups.

Meanwhile, the scanning order may be determined based on at least one of an inverse-transform type, a inverse-transform position, and an area to which inverse-transform is applied.

Herein, when inverse-transform is performed in an order of secondary inverse-transform and primary inverse-transform, a scanning order of an area for which secondary inverse-transform is performed, and a scanning order of an area for which secondary inverse-transform and primary inverse-transform are performed may be differently determined

In detail, the scanning order of the area for which secondary inverse-transform is performed may be determined based on at least one of a size of the current block and an intra-prediction mode of the current block, and the scanning order of the area for which secondary inverse-transform and primary inverse-transform are performed may be determined based on a shape of the current block.

In addition, in step S1930, the decoder may scan and align the transform coefficients of the current block based on the determined scanning unit and scanning order.

In addition, in step S1940, the decoder may perform inverse-transform for the aligned transform coefficients.

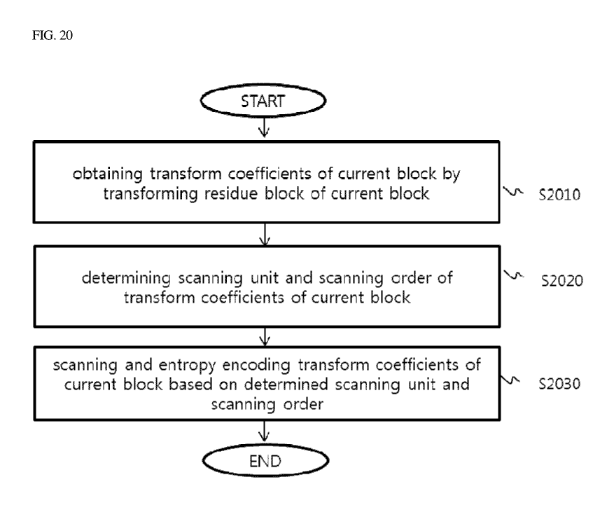

FIG. 20 is a flowchart showing a method for encoding an image according to an embodiment of the present invention.

Referring to FIG. 20, in step S2010, the encoder may obtain transform coefficients of a current block by transforming a residue block of a current block.

In addition, in step S2020, the encoder may determine a scanning unit and a scanning order of the transform coefficients of the current block.

Herein, the scanning unit may be determined as any one of a coefficient group unit, an individual coefficient unit, and a combined unit, and the scanning order may be determined as any one of a diagonal scanning order, a vertical scanning order, a horizontal scanning order, and a combined diagonal scanning order.

Meanwhile, the scanning unit may be determined based on a size of the current block and a preset threshold value, or may be determined based on any one of a shape of the current block and an intra-prediction mode of the current block.

Meanwhile, the scanning order may be determined based on a size of the current block and a preset threshold value, or may be determined based on any one of a shape of the current block and an intra-prediction mode of the current block.

Herein, when scanning in a coefficient group unit is performed, scanning orders different from each other may be applied to scanning within a coefficient group and scanning between coefficient groups.

Meanwhile, the scanning order may be determined based on at least one of a transform type, a transform position, and an area to which transform is applied.

Herein, when transform is performed in an order of primary transform and secondary transform, a scanning order of an area for which primary transform is performed, and a scanning order of an area for which primary transform and secondary transform are performed may be differently determined.

In detail, the scanning order of the area for which primary transform is performed may be determined based on at least one of a size of the current block and an intra-prediction mode of the current block, and the scanning order of the area for which primary transform and secondary transform are performed may be determined based on a shape of the current block.

In addition, in step S2030, the encoder may scan and entropy-encode the transform coefficients of the current block based on the determined scanning unit and scanning order.

The above embodiments may be performed in the same method in an encoder and a decoder.

A sequence of applying to above embodiment may be different between an encoder and a decoder, or the sequence applying to above embodiment may be the same in the encoder and the decoder.

The above embodiment may be performed on each luma signal and chroma signal, or the above embodiment may be identically performed on luma and chroma signals.

A block form to which the above embodiments of the present invention are applied may have a square form or a non-square form.

The above embodiment of the present invention may be applied depending on a size of at least one of a coding block, a prediction block, a transform block, a block, a current block, a coding unit, a prediction unit, a transform unit, a unit, and a current unit. Herein, the size may be defined as a minimum size or maximum size or both so that the above embodiments are applied, or may be defined as a fixed size to which the above embodiment is applied. In addition, in the above embodiments, a first embodiment may be applied to a first size, and a second embodiment may be applied to a second size. In other words, the above embodiments may be applied in combination depending on a size. In addition, the above embodiments may be applied when a size is equal to or greater that a minimum size and equal to or smaller than a maximum size. In other words, the above embodiments may be applied when a block size is included within a certain range.

For example, the above embodiments may be applied when a size of current block is 8×8 or greater. For example, the above embodiments may be applied when a size of current block is 4×4 or greater. For example, the above embodiments may be applied when a size of current block is 16×16 or greater. For example, the above embodiments may be applied when a size of current block is equal to or greater than 16×16 and equal to or smaller than 64×64.

The above embodiments of the present invention may be applied depending on a temporal layer. In order to identify a temporal layer to which the above embodiments may be applied, a corresponding identifier may be signaled, and the above embodiments may be applied to a specified temporal layer identified by the corresponding identifier. Herein, the identifier may be defined as the lowest layer or the highest layer or both to which the above embodiment may be applied, or may be defined to indicate a specific layer to which the embodiment is applied. In addition, a fixed temporal layer to which the embodiment is applied may be defined.

For example, the above embodiments may be applied when a temporal layer of a current image is the lowest layer. For example, the above embodiments may be applied when a temporal layer identifier of a current image is 1. For example, the above embodiments may be applied when a temporal layer of a current image is the highest layer.

A slice type to which the above embodiments of the present invention are applied may be defined, and the above embodiments may be applied depending on the corresponding slice type.

In the above-described embodiments, the methods are described based on the flowcharts with a series of steps or units, but the present invention is not limited to the order of the steps, and rather, some steps may be performed simultaneously or in different order with other steps. In addition, it should be appreciated by one of ordinary skill in the art that the steps in the flowcharts do not exclude each other and that other steps may be added to the flowcharts or some of the steps may be deleted from the flowcharts without influencing the scope of the present invention.

The embodiments include various aspects of examples. All possible combinations for various aspects may not be described, but those skilled in the art will be able to recognize different combinations. Accordingly, the present invention may include all replacements, modifications, and changes within the scope of the claims.

The embodiments of the present invention may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skilled in computer software technology field. Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used for an image encoding/decoding apparatus.

1. A method for decoding an image, the method comprising:
obtaining transform coefficients of a current block by entropy-decoding a bitstream;
determining a scanning unit and a scanning order of the transform coefficients of the current block;
scanning and aligning the transform coefficients of the current block based on the determined scanning unit and scanning order; and
performing inverse-transform for the aligned transform coefficients.

2. The method of claim 1, wherein the scanning unit is determined based on a size of the current block and a preset threshold value.

3. The method of claim 1, wherein the scanning unit is determined based on any one of a shape of the current block and an intra-prediction mode of the current block.

4. The method of claim 1, wherein the scanning unit is determined in any one of a coefficient group unit, an individual coefficient unit, and a combined unit.

5. The method of claim 1, wherein the scanning order is determined based on a size of the current block and a preset threshold value.

6. The method of claim 1, wherein the scanning order is determined based on any one of a shape of the current block and an intra-prediction mode of the current block.

7. The method of claim 1, wherein when the scanning is performed in a coefficient group unit, scanning orders different from each other are applied to scanning within a coefficient group and scanning between coefficient groups.

8. The method of claim 1, wherein the scanning order is determined based on at least one of a type of inverse-transform, a position of inverse-transform, and an area to which inverse-transform is applied.

9. The method of claim 1, wherein when the inverse-transform is performed in an order of secondary inverse-transform and primary inverse-transform, scanning orders are differently determined for an area for which the secondary inverse-transform is performed and an area for which both of the secondary inverse-transform and the primary inverse-transform are performed.

10. The method of claim 9, wherein the scanning order of the area for which the secondary inverse-transform is performed is determined based on at least one of a size of the current block and an intra-prediction mode of the current block, and
the scanning order of the area for which both of the secondary and the primary inverse-transform are performed is determined based on a shape of the current block.

11. A method for encoding an image, the method comprising:
obtaining transform coefficients of a current block by transforming a residue block of the current block;
determining a scanning unit and a scanning order of the transform coefficients of the current block; and
scanning and entropy-encoding the transform coefficients of the current block based on the determined scanning unit and scanning order.

12. The method of claim 11, wherein the scanning unit is determined based on a size of the current block and a preset threshold value.

13. The method of claim 11, wherein the scanning unit is determined based on any one of a shape of the current block and an intra-prediction mode of the current block.

14. The method of claim 11, wherein the scanning order is determined based on a size of the current block and a preset threshold value.

15. The method of claim 11, wherein the scanning order is determined based on any one of a shape of the current block and an intra-prediction mode of the current block.

16. The method of claim 11, wherein when the scanning is performed in a coefficient group unit, scanning orders different from each other are applied to scanning within a coefficient group and scanning between coefficient groups.

17. The method of claim 11, wherein the scanning order is determined based on at least one a transform type, a transform position, and an area to which transform is applied.

18. The method of claim 11, wherein when the transform is performed in an order of primary transform and secondary transform, scanning orders are differently determined for an area for which the primary transform is performed, and for an area for which both of the primary transform and the secondary transform are performed.

19. The method of claim 18, wherein the scanning order of the area for which the primary transform is performed is determined based on at least one of a size of the current block and an intra-prediction mode of the current block, and
the scanning order of the area for which both of the primary transform and the secondary transform are performed is determined based on a shape of the current block.

20. A recording medium for storing a bitstream generated by using an encoding method, the method including:
obtaining transform coefficients of a current block by transforming a residue block of the current block;
determining a scanning unit and a scanning order of the transform coefficients of the current block; and
scanning and entropy-encoding the transform coefficients of the current block based on the determined scanning unit and scanning order.
